(19) United States
(12) Patent Application Publication
(10) Pub. No.: US 2023/0110192 A1
(43) Pub. Date: Apr. 13, 2023

(54) SUPERCONDUCTING MAGNET DEVICE AND METHOD FOR INCREASING TEMPERATURE THEREOF

(71) Applicant: SUMITOMO HEAVY INDUSTRIES, LTD., Tokyo (JP)

(72) Inventor: Kenta DEMURA, Yokosuka-shi (JP)

(73) Assignee: SUMITOMO HEAVY INDUSTRIES, LTD., Tokyo (JP)

(21) Appl. No.: 17/964,872

(22) Filed: Oct. 12, 2022

(30) Foreign Application Priority Data
Oct. 13, 2021 (JP) 2021-168054

(51) Int. Cl. H01F 6/06

(52) U.S. Cl. CPC H01F 6/06

(57) ABSTRACT

A superconducting magnet device includes: a superconducting coil; a vacuum container that accommodates the superconducting coil; a gas cylinder disposed outside the vacuum container and having a gas filling amount determined so as to decrease a degree of vacuum of the vacuum container from a high vacuum to a medium vacuum; and a gas introduction line connecting the gas cylinder to the vacuum container such that a gas is capable of being introduced from the gas cylinder to the vacuum container.

### RELATED APPLICATIONS

The content of Japanese Patent Application No. 2021-168054, on the basis of which priority benefits are claimed in an accompanying application data sheet, is in its entirety incorporated herein by reference.

### BACKGROUND

### Technical Field

A certain embodiment of the present invention relates to a superconducting magnet device and a method for increasing a temperature thereof.

### Description of Related Art

A cryopump is used to evacuate a vacuum container. Since the cryopump is a gas entrapment type vacuum pump, regeneration of periodically discharging a trapped gas to the outside is required. The regeneration of the cryopump may utilize heating with an electric heater or supply of a purge gas for increasing a temperature of a cryogenic surface on which the gas is condensed to a room temperature.

### SUMMARY

According to an aspect of the present invention, there is provided a superconducting magnet device including: a superconducting coil; a vacuum container that accommodates the superconducting coil; a gas cylinder disposed outside the vacuum container and having a gas filling amount determined so as to decrease a degree of vacuum of the vacuum container from a high vacuum to a medium vacuum; and a gas introduction line connecting the gas cylinder to the vacuum container such that a gas is capable of being introduced from the gas cylinder to the vacuum container.

According to another aspect of the present invention, there is provided a method for increasing a temperature of a superconducting magnet device including a superconducting coil and a vacuum container accommodating the superconducting coil, the method including: connecting a gas cylinder to the vacuum container; and introducing a gas from the gas cylinder into the vacuum container, wherein a gas filling amount of the gas cylinder is determined so as to decrease a degree of vacuum of the vacuum container from a high vacuum to a medium vacuum.

### BRIEF DESCRIPTION OF THE DRAWINGS

FIG. 1 is a side view schematically showing a superconducting magnet device according to an embodiment.

FIG. 2 is a flow chart showing an example of a method for increasing a temperature of the superconducting magnet device according to the embodiment.

FIG. 3 is a diagram showing a first modification of a gas introduction unit according to the embodiment.

FIGS. 4A to 4C show a second modification of the gas introduction unit according to the embodiment.

FIG. 5 is a diagram showing a third modification of the gas introduction unit according to the embodiment.

FIG. 6 is a diagram showing a fourth modification of the gas introduction unit according to the embodiment.

FIG. 7 is a diagram showing a fifth modification of the gas introduction unit according to the embodiment.

FIG. 8 is a diagram illustrating a countermeasure against condensation on a vacuum container.

### DETAILED DESCRIPTION

A superconducting magnet device generally includes a vacuum container, also called a cryostat, and a superconducting coil that is cryogenically cooled in the cryostat. For maintenance of the superconducting magnet device, the superconducting coil may be heated by an electric heater so that the temperature thereof is increased from a cryogenic temperature to a room temperature. In order to increase the temperature in a short time, it is desirable to cause a large current to flow through a heater and an electric wiring to the heater. However, in this case, a risk of occurrence of troubles such as excessive heating by the heater or fusing of the electric wiring is high and there are safety concerns.

As another method for quickening the temperature increase, it is also possible to open the cryostat to an atmosphere or to supply a high-pressure gas into the cryostat, to fill the inside of the cryostat with a gas at a pressure higher than an atmospheric pressure and to facilitate heat transfer to the superconducting coil inside the cryostat from a surrounding environment via the gas. However, when such a large amount of the gas is introduced, the entire cryostat is often cooled by a cryogenic part such as the superconducting coil and a radiation shield surrounding the superconducting coil and a problem in which a surface of the cryostat is condensed may occur. The cryostat of the superconducting magnet device is often at least partially surrounded by a ferrous magnetic shield to reduce magnetic field leakage to the outside. Condensed water may adhere to the magnetic shield and cause rust.

It is desirable to quickly increase the temperature of the superconducting magnet device.

Hereinafter, embodiments for carrying out the present invention will be described in detail with reference to the drawings. In the description and drawings, the same or equivalent components, members, and processes are denoted by the same reference numerals, and overlapping descriptions are omitted as appropriate. The scales and shapes of the illustrated parts are set for convenience in order to facilitate explanation, and should not be construed in a limited manner unless otherwise specified. The embodiment is an example and does not limit the scope of the present invention. All features and combinations thereof described in the embodiment are not necessarily essential to the invention.

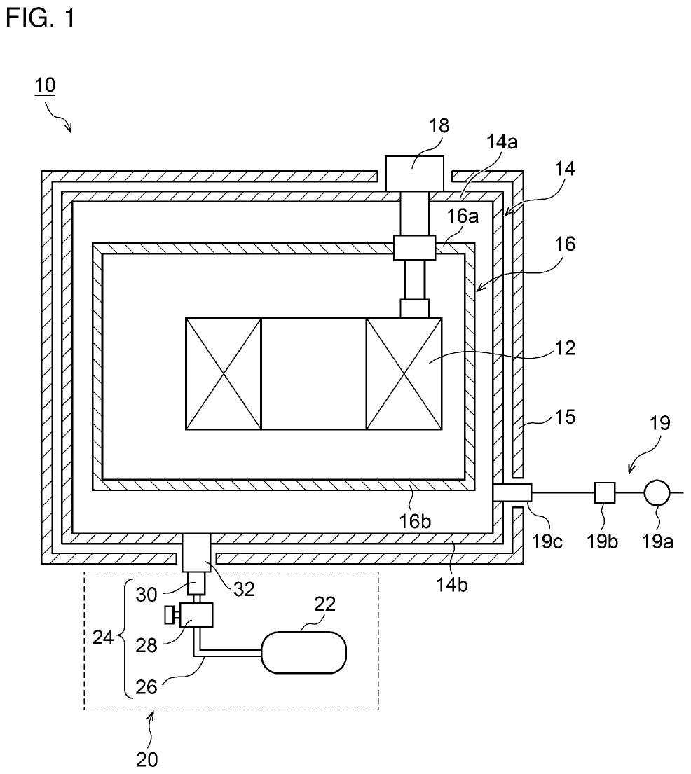

FIG. 1 is a diagram schematically showing a superconducting magnet device 10 according to an embodiment. The superconducting magnet device 10 can be mounted on a high-magnetic field utilization device as a magnetic field source of, for example, a single crystal pulling device, a nuclear magnetic resonance (NMR) system, a magnetic resonance imaging (MRI) system, an accelerator such as a cyclotron, a high energy physical system such as a nuclear fusion system, or other high-magnetic field utilization devices and can generate a high magnetic field required for the device.

The superconducting magnet device 10 includes a superconducting coil 12, a vacuum container 14, a magnetic shield 15, a radiation shield 16, a cryocooler 18, an evacuation system 19, and a gas introduction unit 20.

The superconducting coil 12 is disposed in the vacuum container 14. The superconducting coil 12 is thermally coupled to a cryocooler 18, such as a two-stage Gifford-McMahon (GM) cryocooler, installed in the vacuum container 14 and is used in a state of being cooled to a cryogenic temperature equal to or lower than a superconducting transition temperature. In this embodiment, the superconducting magnet device 10 is configured as a so-called conduction cooling type in which the superconducting coil 12 is directly cooled by the cryocooler 18. Note that, in another embodiment, the superconducting magnet device 10 may be configured as an immersion cooling type in which the superconducting coil 12 is immersed in a cryogenic liquid coolant such as liquid helium.

The vacuum container 14 is an adiabatic vacuum container that provides a cryogenic vacuum environment suitable for bringing the superconducting coil 12 into a superconducting state, and is also called a cryostat. Typically, the vacuum container 14 has a columnar shape or a cylindrical shape with a hollow portion in a central part thereof. Therefore, the vacuum container 14 includes substantially flat circular or annular top plate 14a and bottom plate 14b, and a cylindrical side wall (cylindrical outer peripheral wall, or coaxially disposed cylindrical outer peripheral wall and inner peripheral wall) connecting the top plate and the bottom plate. The cryocooler 18 may be installed on the top plate 14a of the vacuum container 14. The vacuum container 14 is formed of, for example, a metallic material such as stainless steel or other suitable high-strength materials to withstand an ambient pressure (for example, atmospheric pressure).

The magnetic shield 15 covers the top plate 14a, the bottom plate 14b, and the cylindrical side wall (at least the outer peripheral wall) connecting the top plate and the bottom plate of the vacuum container 14, in order to suppress leakage of a magnetic field generated by the superconducting coil 12 to the outside. The magnetic shield 15 is formed of, for example, a magnetic material such as iron. In this embodiment, the magnetic shield 15 is provided as a separate member from the vacuum container 14 and is fixed outside the vacuum container 14. However, in other embodiments, at least a part of the magnetic shield 15 may be integrated with the vacuum container 14. For example, at least a part of the top plate 14a, the bottom plate 14b, and the side wall connecting the top plate and the bottom plate of the vacuum container 14 may be formed of a magnetic material so as to function as the magnetic shield 15.

The radiation shield 16 is disposed to surround the superconducting coil 12 within the vacuum container 14. The radiation shield 16 includes a top plate 16a and a bottom plate 16b facing the top plate 14a and the bottom plate 14b of the vacuum container 14, respectively. The top plate 16a and the bottom plate 16b of the radiation shield 16 have substantially flat circular or annular shapes similar to the vacuum container 14. Further, the radiation shield 16 includes a cylindrical side wall (cylindrical outer peripheral wall or coaxially disposed cylindrical outer peripheral wall and inner peripheral wall) connecting the top plate 16a and the bottom plate 16b. The radiation shield 16 is formed of, for example, pure copper (for example, oxygen-free copper, tough pitch copper, or the like), or other highly thermally conductive metals. The radiation shield 16 can block radiant heat from the vacuum container 14, and thermally protect a low-temperature section such as the superconducting coil 12, which is disposed inside the radiation shield 16 and cooled to a lower temperature than the radiation shield 16, from the radiant heat.

A first cooling stage of the cryocooler 18 is thermally coupled to the top plate 16a of the radiation shield 16, and a second cooling stage of the cryocooler 18 is thermally coupled to the superconducting coil 12 inside the radiation shield 16. During operation of the superconducting magnet device 10, the radiation shield 16 is cooled to a first cooling temperature, for example, 30K to 70K, by the first cooling stage of the cryocooler 18, and the superconducting coil 12 is cooled to a second cooling temperature lower than the first cooling temperature, for example, 3K to 20K (for example, about 4K) by the second cooling stage of the cryocooler 18. The superconducting coil 12 cooled to a cryogenic temperature in this way can generate a desired high magnetic field by being powered by a coil power supply (not shown) disposed outside the vacuum container 14.

The evacuation system 19 includes a vacuum pump 19a and a vacuum valve 19b, and is configured to evacuate the vacuum container 14. The evacuation system 19 is connected to a connection port 19c of the vacuum container 14. The vacuum pump 19a may be, for example, a turbomolecular pump, a rotary pump, any other suitable vacuum pump, or a combination thereof. The vacuum valve 19b may be, for example, an on/off valve, and the evacuation system 19 can evacuate the vacuum container 14 when both the vacuum pump 19a and the vacuum valve 19b are turned on. The connection port 19c may have a vacuum valve different from the vacuum valve 19b. During operation of the superconducting magnet device 10, the vacuum valve of the connection port 19c may be closed, thereby maintaining the vacuum inside the vacuum container 14.

The gas introduction unit 20 includes a gas cylinder 22 and a gas introduction line 24 disposed outside the vacuum container 14. As described later, a gas filling amount of the gas cylinder 22 is determined so as to decrease a degree of vacuum of the vacuum container 14 from a high vacuum to a medium vacuum. The gas introduction line 24 connects the gas cylinder 22 to the vacuum container 14 such that the gas can be introduced from the gas cylinder 22 to the vacuum container 14.

In this embodiment, the gas introduction line 24 includes a gas introduction pipe 26, a gas introduction valve 28, and a gas outlet 30. The gas introduction pipe 26 connects the gas cylinder 22 to an inlet side of the gas introduction valve 28. As described later, the gas introduction valve 28 closes the gas introduction line 24 when the superconducting coil 12 is in operation and opens the gas introduction line 24 to increase the temperature of the superconducting coil 12 when the superconducting coil 12 is not in operation. A gas outlet 30 serving as a terminal end of the gas introduction line 24 is attached to an outlet side of the gas introduction valve 28.

The kind of gas with which the gas cylinder 22 is filled maybe a low boiling point gas, for example, a gas with a boiling point of 100K or less under an atmospheric pressure, in order to suppress condensation due to contact with a cryogenic part. An inert gas is easy to handle and convenient. Therefore, in this embodiment, the gas cylinder 22 may be filled with a helium gas. Alternatively, the gas cylinder 22 maybe filled with a nitrogen gas.

Generally, during operation of the superconducting magnet device 10, that is, during cooling operation of the cryocooler 18, the degree of vacuum of the vacuum container 14 is maintained at a high vacuum (typically, for example, a pressure of less than 0.1 Pa). This is because after the vacuum container 14 is evacuated by the evacuation system 19, the gas remaining in the vacuum container 14 is captured by cryotrapping on a cryogenic surface (for example, surfaces of the superconducting coil 12, the radiation shield 16, and the cryocooler 18). Therefore, an initial pressure inside the vacuum container 14 before the gas is supplied from the gas introduction unit 20 can generally be regarded as a high vacuum.

The amount of gas with which the gas cylinder 22 is filled is determined so as to decrease the degree of vacuum of the vacuum container 14 from a high vacuum to a medium vacuum. Here, the medium vacuum may be, for example, a pressure range of 0.1 to 3000 Pa, or a pressure range of 0.1 to 100 Pa. Therefore, the gas filling amount of the gas cylinder 22 may be determined so as to increase the pressure of the vacuum container 14 from an initial pressure of less than 0.1 Pa to a set pressure of 3000 Pa or less, or to a set pressure of 100 Pa or less. The set pressure may preferably be a pressure selected from a pressure range of 1 to 10 Pa from the viewpoint of promoting heat transfer in the vacuum container 14 by gas introduction and also reducing the size of the gas cylinder 22. Therefore, the gas filling amount of the gas cylinder 22 may be determined so as to increase the pressure of the vacuum container 14 from the initial pressure of less than 0.1 Pa to the set pressure of 10 Pa or less.

The vacuum container 14 is provided with a gas introduction port 32 that is connected to the gas introduction line 24 and receives the gas. In this example, the gas introduction port 32 is provided in the bottom plate 14b of the vacuum container 14, but is not limited to this example. However, the gas introduction port 32 may be provided in other parts of the vacuum container 14 such as the top plate 14a or the side wall connecting the top plate 14a and the bottom plate 14b.

The gas introduction unit 20 is detachable from the vacuum container 14. The gas introduction port 32 and the gas outlet 30 of the gas introduction line 24 are joints that are airtightly coupled to each other. When the gas introduction port 32 and the gas outlet 30 of the gas introduction line 24 are coupled and the gas introduction valve 28 is opened, the gas stored in the gas cylinder 22 is supplied from the gas cylinder 22 into the vacuum container 14 through the gas introduction line 24 and the gas introduction port 32.

By opening the gas introduction valve 28, the entire amount of the gas of the gas cylinder 22 is supplied to the vacuum container 14. The gas introduction unit 20 is a disposable gas source and is replaced after use. The used gas introduction unit 20 can be removed from the vacuum container 14 and replaced with a new unit.

The gas introduction line 24 is configured to have sufficient airtightness so that the gas of the gas cylinder 22 does not leak outside from the gas introduction unit 20. A junction between the gas introduction pipe 26 and the gas cylinder 22 and a junction between the gas introduction pipe 26 and the gas introduction valve 28 are joined by a joining method for maintaining sufficient airtightness, such as brazing or welding. Therefore, as long as the gas introduction valve 28 is closed, the gas stored in the gas cylinder 22 does not leak to the outside.

Similarly, the gas introduction valve 28 and the gas outlet 30 are joined so as to maintain sufficient airtightness. Therefore, when the gas outlet 30 is airtightly coupled to the gas introduction port 32, there is no leakage of the gas into the vacuum container 14 from a surrounding environment of the vacuum container 14 through a coupling part between the gas outlet 30 and the gas introduction port 32 and a junction between the gas introduction valve 28 and the gas outlet 30.

In order to ensure prevention of gas leakage from the gas introduction unit 20 to the outside, the gas introduction unit 20 may be subjected to leak checking in advance. As an example of an inspection method, the gas introduction unit 20 may be prepared before being attached to the vacuum container 14 and carried into an inspection vacuum container to which a leak detector is connected. The presence or absence of gas leakage can be determined from detection results of the leak detector before and after the gas introduction unit 20 is held in the evacuated inspection vacuum container for a predetermined time.

Further, another inspection may be performed to ensure prevention of gas leakage into the vacuum container 14 through the gas introduction unit 20. The gas introduction unit 20 may be prepared before being attached to the vacuum container 14, and a pressure gauge may be connected to the gas outlet 30 thereof. The presence or absence of gas leakage can be determined from measurement results of the pressure gauge before and after the gas introduction unit 20 is held for a predetermined time in a state in which the gas introduction valve 28 is closed.

By attaching the gas introduction unit 20 that has passed these two inspections to the vacuum container 14, the risk of gas leakage associated with the gas introduction unit 20 can be minimized.

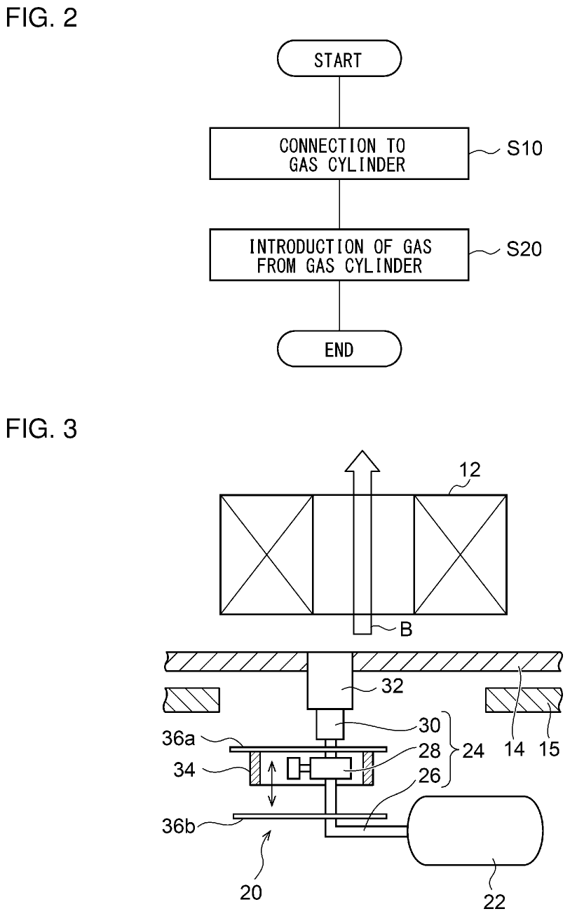

FIG. 2 is a flow chart showing an example of a method for increasing the temperature of the superconducting magnet device 10 according to the embodiment. This method includes connecting the gas cylinder 22 to the vacuum container 14 (S10) and introducing a gas from the gas cylinder 22 into the vacuum container 14 (S20).

The step of connecting the gas cylinder 22 (S10) may be performed at any timing during the manufacture and use of the superconducting magnet device 10. For example, the gas introduction unit 20 may be mounted to the vacuum container 14 in advance in a manufacturing process of the superconducting magnet device 10, and the superconducting magnet device 10 may be shipped in this state and installed at a place of use. Alternatively, the gas introduction unit 20 may not be mounted to the vacuum container 14 in advance, and the gas introduction unit 20 may be mounted to the vacuum container 14 afterward when the superconducting magnet device 10 is already in operation at the place of use. The gas introduction unit 20 may be mounted to the vacuum container 14 when the operation of the superconducting magnet device 10 is stopped in preparation for performing maintenance on the superconducting magnet device 10. The mounting of the gas introduction unit 20 into the vacuum container 14 may be performed by a service person dispatched by a manufacturer of the superconducting magnet device 10 or by a user of the superconducting magnet device 10.

At the step in which the gas introduction unit 20 is mounted to the vacuum container 14, the gas introduction valve 28 is closed. In particular, after the gas introduction unit 20 is mounted to the vacuum container 14, the gas introduction valve 28 is always closed during operation of the superconducting magnet device 10. As a result, the gas introduction line 24 is blocked, and the gas does not flow from the gas cylinder 22 into the vacuum container 14.

Typically, once the superconducting magnet device 10 is started for operation, the superconducting magnet device 10 is operated continuously for a considerably long period (for example, several years or longer). After such a long period of normal operation, the superconducting magnet device 10 may undergo maintenance as required. The operation of the superconducting magnet device 10 is stopped for maintenance, that is, the current supply to the superconducting coil 12 is stopped and the cooling operation of the cryocooler 18 is also stopped. At this point in time, components of the superconducting magnet device 10, such as the superconducting coil 12 and the cryocooler 18, are still cryogenically cooled, but it is desirable to bring the components to a room temperature for a worker to access the components for maintenance. Therefore, in this embodiment, the gas supplied from the gas introduction unit 20 to the vacuum container 14 is used to accelerate the temperature increase of the superconducting magnet device 10.

The step of introducing the gas from the gas cylinder 22 (S20) can be performed at any timing when the superconducting magnet device 10 is not in operation after the step of connecting the gas cylinder 22 (S10). In this step, the gas introduction valve 28 is operated and opened. The gas stored in the gas cylinder 22 is supplied to the vacuum container 14 through the gas introduction line 24 and the gas introduction port 32. The introduction of the gas from the gas introduction unit 20 into the vacuum container 14 may be performed by a service person dispatched by the manufacturer of the superconducting magnet device 10 or by a user of the superconducting magnet device 10.

The vacuum container 14 is pressurized from a high vacuum initial pressure to a medium vacuum set pressure. For example, the vacuum container 14 is pressurized from an initial pressure of less than 0.1 Pa to a set pressure of 3000 Pa or less or 100 Pa or less by the gas supplied from the gas cylinder 22. Preferably, the vacuum container 14 is pressurized to a set pressure selected from a pressure range of 1 to 10 Pa by the gas supplied from the gas cylinder 22.

The gas supplied to the vacuum container 14 contributes to heat transfer between an outer surface of the vacuum container 14 exposed to the surrounding environment (for example, a room temperature) and an object to be cooled such as the superconducting coil 12 inside the vacuum container 14, and can efficiently increase a temperature of the object to be cooled in the vacuum container 14 toward a surrounding environmental temperature. According to the study of the present inventor, in order to obtain this advantage, it is sufficient to increase a pressure level in the vacuum container 14 to a medium vacuum of about several Pa. Therefore, according to the embodiment, the temperature of the superconducting magnet device 10 can be increased more quickly than the natural temperature increase.

After completion of the temperature increase, necessary maintenance can be performed on the components of the superconducting magnet device 10 such as the superconducting coil 12 and the cryocooler 18. After the maintenance is completed, the vacuum container 14 is evacuated by the evacuation system 19, and then the cryocooler 18 is operated again. The superconducting coil 12 and the radiation shield 16 can be re-cooled and the superconducting magnet device 10 can be started for operation again.

By the way, the high-pressure gas cylinder widely used in industry generally has a large volume of several hundred to several thousand liters and is filled with a gas at a high pressure of 1 MPa or more. When the gas is supplied from such a gas cylinder to the vacuum container, the pressure inside the vacuum container is easily increased to an atmospheric pressure or higher. It is practically difficult to adjust the pressure inside the vacuum container to an intermediate pressure (for example, a medium vacuum) to the atmospheric pressure or lower. Further, the cylinder is large and occupies a large space.

In contrast, according to the embodiment, the gas filling amount of the gas cylinder 22 maybe substantially small. According to the estimation of the present inventor, for example, the amount of the gas sufficient to pressurize the vacuum container 14 having a large volume of 10000 L class from a high vacuum to a medium vacuum can be provided by the gas cylinder 22 having an internal volume of about 0.1 L at a filling pressure of 0.6 MPa at a room temperature. A cylindrical container having a height of only about 10 cm can be used for such a gas cylinder 22.

Therefore, an appropriate amount of the gas can be introduced into the vacuum container 14 by simple operation of opening the gas introduction valve 28. It is not necessary to adjust the pressure inside the vacuum container 14, which is considered to be highly difficult when an existing large gas cylinder is used. In addition, since a small cylinder can be used, the gas introduction unit 20 is also space-saving.

Further, as described above, when an excessive amount of the gas is supplied to the vacuum container 14 to set the pressure to an atmospheric pressure or higher, the entire vacuum container 14 is cooled by the cryogenic part such as the superconducting coil 12 via the gas, and condensation or freezing is often caused on the outer surface of the vacuum container 14. Since the superconducting magnet device 10 is usually covered with the magnetic shield 15 made of iron, there is a concern that condensed water may adhere to the magnetic shield 15 and cause rust.

On the other hand, in the embodiment, since the gas filling amount of the gas cylinder 22 is limited to a specified small amount, it is possible to avoid excessive pressure increase of the vacuum container 14, and as a result, the above-mentioned problem can also be dealt with beforehand.

The present invention has been described above based on the examples. It will be understood by those skilled in the art that the present invention is not limited to the above-described embodiment, and that various modifications are possible, and such modifications are also within the scope of the present invention. Various features described in relation to the certain embodiment are also applicable to other embodiments. A new embodiment resulting from combination has the effects of each of the combined embodiments.

FIG. 3 is a diagram showing a first modification of the gas introduction unit 20 according to the embodiment. The gas introduction unit 20 includes the gas cylinder 22 and the gas introduction line 24, and the gas introduction line 24 includes the gas introduction pipe 26, the gas introduction valve 28, and the gas outlet 30 as in the above-described embodiment. The gas outlet 30 is coupled to the gas introduction port 32 of the vacuum container 14.

In the first modification, a restrictor 34 is provided to restrict access to the gas introduction valve 28 during operation of the superconducting coil 12. The restrictor 34 is formed of a magnetic material such as iron and is attracted toward the superconducting coil 12 by a magnetic field B when the superconducting coil 12 generates the magnetic field B. The magnetic shield 15 maybe removed in the vicinity of the restrictor 34 and the gas introduction unit 20 such that the magnetic field B can effectively act on the restrictor 34.

A pair of positioning members 36a and 36b are provided on both sides of the gas introduction valve 28 for positioning the restrictor 34. These positioning members 36a and 36b maybe a pair of positioning plates facing each other and may be fixed to the gas introduction pipe 26 so as to be parallel to each other. One positioning member 36a is disposed between the gas introduction valve 28 and the gas outlet 30. As shown in FIG. 3, when the magnetic field B attracts the restrictor 34, the restrictor 34 abuts against the positioning member 36a and is positioned at a position surrounding the gas introduction valve 28. The other positioning member 36b is disposed between the gas introduction valve 28 and the gas cylinder 22 below the opposing positioning member 36a. The positioning member 36b receives the restrictor 34 that drops due to gravity when the superconducting coil 12 is not in operation in which the magnetic field B is not generated.

The restrictor 34 has a ring-like or short-cylindrical shape and is sized to surround the gas introduction valve 28. When the restrictor 34 surrounds the gas introduction valve 28, the restrictor 34 can restrict access to the gas introduction valve 28 by a user. In order to indicate the role of the restrictor 34 to the user, a warning display such as “normally closed” or “operation prohibited” may be applied to a surface visible to the user, such as an outer surface.

Therefore, when the magnetic field B is generated during the operation of the superconducting coil 12, the restrictor 34 is attracted by the magnetic field B to abut against the positioning member 36a and to surround the gas introduction valve 28. The access to the gas introduction valve 28 is blocked by the restrictor 34 and the user cannot operate the gas introduction valve 28. Thus, it is possible to reduce the risk that the user erroneously operates the gas introduction valve 28 during the operation of the superconducting magnet device 10 and erroneously introduces the gas from the gas introduction unit 20 into the vacuum container 14. On the other hand, when the superconducting coil 12 is not in operation, since the magnetic field B is not generated, the restrictor 34 is separated from the gas introduction valve 28. The user can operate the gas introduction valve 28 to introduce the gas from the gas introduction unit 20 into the vacuum container 14 without being prevented from accessing the restrictor 34.

In this embodiment, the restrictor 34 is operated using, but not limited to, a magnetic force generated by the superconducting coil 12. The restrictor 34 may be movable between a restriction position restricting the access to the gas introduction valve 28 and a release position permitting the access by other power or manually.

Alternatively, the restrictor 34 maybe a component that restricts the access to the gas introduction valve 28 by being mounted to seal the gas introduction valve 28, such as a seal affixed to the gas introduction valve 28 to block the operation of the gas introduction valve 28.

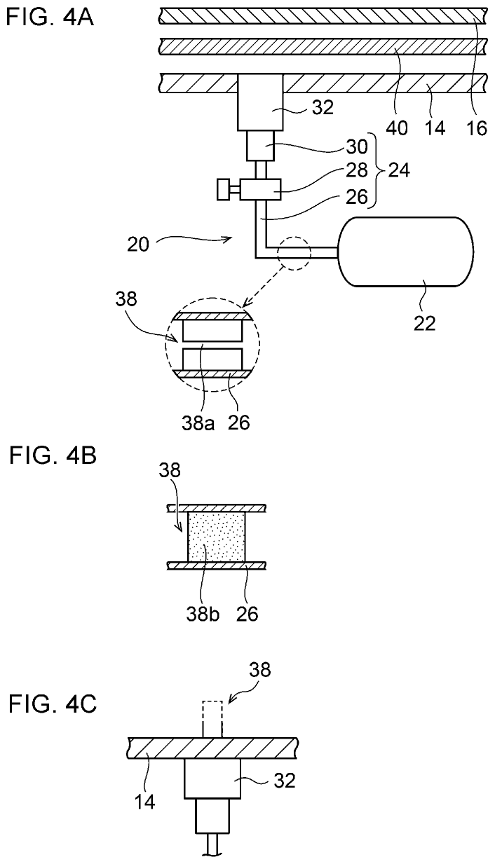

FIGS. 4A to 4C are diagrams showing a second modification of the gas introduction unit 20 according to the embodiment. The gas introduction unit 20 includes the gas cylinder 22 and the gas introduction line 24, and the gas introduction line 24 includes the gas introduction pipe 26, the gas introduction valve 28, and the gas outlet 30 as in the above-described embodiment. The gas outlet 30 is coupled to the gas introduction port 32 of the vacuum container 14.

In the second modification, a flow path resistance portion 38 that suppresses a flow velocity of the gas flowing into the vacuum container 14 from the gas introduction port 32 is provided in the gas introduction line 24, and in this example, provided in the gas introduction pipe 26. A multilayer insulation (MLI) 40 is often provided within the vacuum container 14.

The multilayer insulation 40 is usually installed between the vacuum container 14 and the radiation shield 16 to enhance a thermal insulation property of the vacuum container 14. The multilayer insulation 40 is disposed to face the gas introduction port 32 inside the vacuum container 14. The multilayer insulation 40 has a delicate membrane structure.

The flow path resistance portion 38 may be a constricted portion 38a provided in the gas introduction pipe 26, as shown in FIG. 4A. Alternatively, the flow path resistance portion 38 may be a porous portion 38b provided inside the gas introduction pipe 26, as shown in FIG. 4B. As still another example, the flow path resistance portion 38 may be provided in the gas introduction port 32 as shown in FIG. 4C. For example, the flow path resistance portion 38 may be provided at a tip part of the gas introduction port 32 located inside the vacuum container 14.

As described above, by providing the flow path resistance portion 38 in the gas introduction line 24 or the gas introduction port 32, the flow velocity of the gas blown into the vacuum container 14 from the gas introduction port 32 can be suppressed. Thus, it is possible to reduce the risk that the multilayer insulation 40 facing the gas introduction port 32 is damaged by the blowing gas.

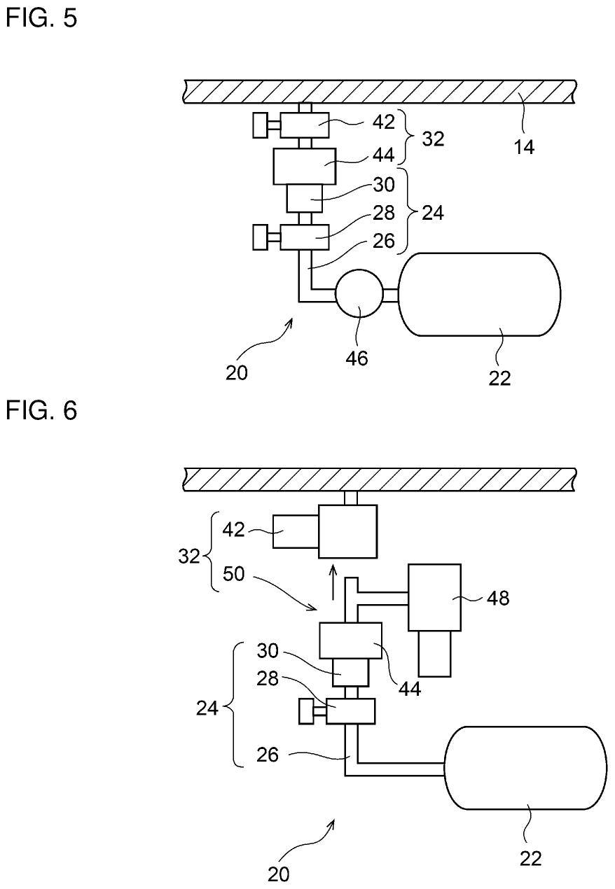

FIG. 5 is a diagram showing a third modification of the gas introduction unit 20 according to the embodiment. The gas introduction unit 20 includes the gas cylinder 22 and the gas introduction line 24, and the gas introduction line 24 includes the gas introduction pipe 26, the gas introduction valve 28, and the gas outlet 30 as in the above-described embodiment. The gas outlet 30 is coupled to the gas introduction port 32 of the vacuum container 14.

In the third modification, the gas introduction port 32 includes an additional gas introduction valve 42 that opens and closes the gas introduction port 32 and a joint portion 44 coupled to the gas outlet 30 of the gas introduction line 24. In this way, since the gas introduction valve 28 of the gas introduction unit 20 and the additional gas introduction valve 42 are connected in series, erroneous introduction of the gas from the gas cylinder 22 to the vacuum container 14 can be more reliably prevented.

Further, a pressure gauge 46 may be provided in the gas introduction line 24, for example, in the gas introduction pipe 26. In this way, leak checking can be performed before introducing the gas from the gas introduction unit 20 into the vacuum container 14.

The leak checking can be performed, for example, by the following procedure. First, the gas introduction valve 28 of the gas introduction unit 20 is opened in a state in which the gas introduction valve 42 of the gas introduction port 32 is closed. Then, a space from the joint portion 44 of the gas introduction port 32 to the gas cylinder 22 is filled with the gas. In this state, the pressure measured by the pressure gauge 46 is monitored for a predetermined period. When a pressure fluctuation is not detected, it can be determined that there is no leakage at a coupling part between the gas outlet 30 and the joint portion 44, so that the gas introduction valve 42 is opened and the gas is introduced from the gas introduction unit 20 into the vacuum container 14. When the pressure fluctuation is detected, the gas introduction valve 28 can be closed, and the gas introduction unit 20 can be removed and replaced with a new gas introduction unit 20.

FIG. 6 is a diagram showing a fourth modification of the gas introduction unit 20 according to the embodiment. The gas introduction unit 20 includes the gas cylinder 22 and the gas introduction line 24, and the gas introduction line 24 includes the gas introduction pipe 26, the gas introduction valve 28, and the gas outlet 30 as in the above-described embodiment. The gas introduction port 32 of the vacuum container 14 includes the additional gas introduction valve 42 that opens and closes the gas introduction port 32 and the joint portion 44 coupled to the gas outlet 30 of the gas introduction line 24.

In the fourth modification, an evacuation valve 48 is provided in the gas introduction port 32. The gas introduction port 32 includes the additional gas introduction valve 42 and an intermediate component 50 attachable thereto. The intermediate component 50 includes the joint portion 44 and the evacuation valve 48. The joint portion 44 and the evacuation valve 48 are provided so as to branch from the gas introduction valve 42 when the intermediate component 50 is attached to the gas introduction valve 42. Therefore, the evacuation valve 48 is branch-connected between the gas introduction valve 28 of the gas introduction line 24 and the additional gas introduction valve 42 of the gas introduction port 32. The evacuation valve 48 is connected to a vacuum pump (for example, the vacuum pump 19a shown in FIG. 1).

In this case, the gas introduction unit 20 and the intermediate component 50 can be attached to the vacuum container 14 by the following procedure, for example. First, the intermediate component 50 is attached to the gas introduction valve 42, and the gas outlet 30 of the gas introduction unit 20 is attached to the joint portion 44 of the intermediate component 50. Alternatively, the intermediate component 50 maybe attached to the gas introduction valve 42 in a state in which the gas introduction unit 20 is attached to the intermediate component 50. Next, the evacuation valve 48 is opened to evacuate a space from the gas introduction valve 42 of the gas introduction port 32 to the gas introduction valve 28 of the gas introduction unit 20. Then, the evacuation valve 48 is closed. In this way, the gas introduction unit 20 can be easily attached to the superconducting magnet device 10 to which the gas introduction unit 20 has not yet been attached, during the operation of the superconducting magnet device 10.

The evacuation valve 48 can be used to evacuate the vacuum container 14 in place of or together with the evacuation system 19 shown in FIG. 1. In this case, since a large amount of the gas can flow from the vacuum container 14 to the gas introduction valve 42 and the evacuation valve 48, Cv values of the gas introduction valve 42 and the evacuation valve 48 may be larger than a Cv value of the gas introduction valve 28.

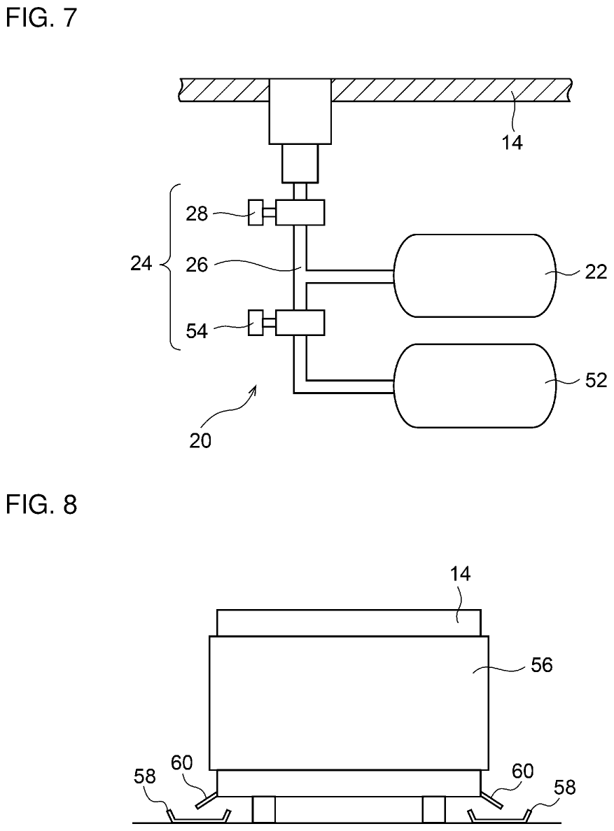

FIG. 7 is a diagram showing a fifth modification of the gas introduction unit 20 according to the embodiment. In the fifth modification, the gas introduction unit 20 includes, in addition to the gas cylinder 22, an additional gas cylinder 52 filled with a gas different from that of the gas cylinder 22. The additional gas cylinder 52 maybe filled with a gas having a boiling point higher than that of the gas cylinder 22, for example, a nitrogen gas.

The gas introduction line 24 is configured to be switchable between connection between the gas cylinder 22 and the vacuum container 14 and connection between the additional gas cylinder 52 and the vacuum container 14. For example, an additional gas introduction valve 54 connecting the additional gas cylinder 52 to the gas introduction pipe 26 may be provided. The additional gas introduction valve 54 is connected to the gas introduction pipe 26 between the gas cylinder 22 and the gas introduction valve 28.

In this way, the kind of gas to be used can be switched according to the temperature. For example, in an initial stage of temperature increase, a gas having a low boiling point such as a helium gas can be introduced into the vacuum container 14 from the gas cylinder 22, and when the temperature increases to some extent (for example, when the temperature increases above a liquid nitrogen temperature), a gas having a high boiling point such as a nitrogen gas can be introduced into the vacuum container 14 from the additional gas cylinder 52.

Alternatively, the additional gas cylinder 52 may also be filled with the same kind of gas as that of the gas cylinder 22. In this way, the gas can be supplied to the vacuum container 14 in a stepwise manner from these two gas cylinders.

FIG. 8 is a diagram illustrating a countermeasure against condensation on the vacuum container 14. When it is desired to deal with condensation on a surface (for example, side surface) of the vacuum container 14, a moisture absorbent 56 may be provided so as to cover at least a part to be dealt with of the surface of the vacuum container 14. Further, a water receiving tray 58 may be placed below the vacuum container 14 in order to collect dripping condensed water. A water guide plate 60 may be installed on the surface of the vacuum container 14 for allowing the condensed water to flow to the water receiving tray.

Although the present invention has been described using specific terms based on the embodiment, the embodiment only shows one aspect of the principle and application of the invention, and the embodiment allows for many modifications and changes in arrangement without departing from the concept of the invention as defined in the claims.

It should be understood that the invention is not limited to the above-described embodiment, but may be modified into various forms on the basis of the spirit of the invention. Additionally, the modifications are included in the scope of the invention.

What is claimed is:

1. A superconducting magnet device comprising:
a superconducting coil;
a vacuum container that accommodates the superconducting coil;
a gas cylinder disposed outside the vacuum container and having a gas filling amount determined so as to decrease a degree of vacuum of the vacuum container from a high vacuum to a medium vacuum; and
a gas introduction line connecting the gas cylinder to the vacuum container such that a gas is capable of being introduced from the gas cylinder to the vacuum container.

2. The superconducting magnet device according to claim 1,
wherein the vacuum container includes a gas introduction port that is connected to the gas introduction line and that receives the gas, and
wherein the gas introduction line includes a gas introduction valve that closes the gas introduction line when the superconducting coil is in operation, and opens the gas introduction line to increase a temperature of the superconducting coil when the superconducting coil is not in operation.

3. The superconducting magnet device according to claim 2, further comprising a restrictor that restricts access to the gas introduction valve when the superconducting coil is in operation.

4. The superconducting magnet device according to claim 2,
wherein the gas introduction line or the gas introduction port is provided with a flow path resistance portion that suppresses a flow velocity of the gas flowing into the vacuum container from the gas introduction port.

5. The superconducting magnet device according to claim 4, further comprising a multilayer insulation disposed facing the gas introduction port within the vacuum container.

6. The superconducting magnet device according to claim 2,
wherein the gas introduction port includes an additional gas introduction valve for opening and closing the gas introduction port.

7. The superconducting magnet device according to claim 6, further comprising an evacuation valve branch-connected between the gas introduction valve of the gas introduction line and the additional gas introduction valve of the gas introduction port.

8. The superconducting magnet device according to claim 1, further comprising an additional gas cylinder filled with a gas different from the gas of the gas cylinder,
wherein the gas introduction line is configured to be switchable between connection between the gas cylinder and the vacuum container and connection between the additional gas cylinder and the vacuum container.

9. A method for increasing a temperature of a superconducting magnet device including a superconducting coil and a vacuum container accommodating the superconducting coil, the method comprising:
connecting a gas cylinder to the vacuum container; and
introducing a gas from the gas cylinder into the vacuum container,
wherein a gas filling amount of the gas cylinder is determined so as to decrease a degree of vacuum of the vacuum container from a high vacuum to a medium vacuum.
